(19) United States
(12) Patent Application Publication
(10) Pub. No.: US 2026/0093623 A1
(43) Pub. Date: Apr. 2, 2026

(54) MULTI-HOST REMOTE MEMORY ACCESS

(71) Applicants: Advanced Micro Devices, Inc., Santa Clara, CA (US); ATI Technologies ULC, Markham (CA)

(72) Inventors: Alexandru Radu, Richmond Hill (CA); Felix Kuehling, Toronto (CA); Anthony Asaro, Toronto (CA); Joseph L. Greathouse, Austin, TX (US); Khaled Hamidouche, Austin, TX (US); Philip Ng, Toronto (CA)

(21) Appl. No.: 18/898,851

(22) Filed: Sep. 27, 2024

(51) Int. Cl. G06F 12/02; G06F 12/06; G06F 13/16

(52) U.S. Cl. CPC G06F 12/0292; G06F 12/0653; G06F 13/1642

(57) ABSTRACT

An apparatus and method for efficiently performing remote memory access requests among multiple processing nodes. In various implementations, a computing system has a first node and a second node. Each of these nodes has a corresponding virtual address space in the computing system, and each node assigns subdivisions of the virtual address spaces to multiple clients of the node. The nodes assign a subset of a first virtual address space of a first client in the first node to remote data stored in a second virtual address space of a second client in the second node. Remote presence check (RPC) circuits of the nodes assign the second virtual address space to a subset of a network physical address (NPA) space. The RPC circuits of the nodes use assignments to the NPA space to verify that address mappings in TLBs are still available prior to routing memory access requests.

### BACKGROUND

### Description of the Relevant Art

The parallelization of tasks is used to increase the throughput of computing systems. To maintain high throughput, multiple applications exploit parallel processing and large amounts of shared memory. Examples of these applications are machine learning applications, entertainment and real-time applications, as well as some business, scientific, medical and other applications. Compilers extract a variety of types of tasks from this variety of types of applications to execute in parallel on the system hardware. To support the concurrent processing of the variety of types of tasks, the hardware of the computing system uses heterogeneous integration in which multiple types of clients are integrated to provide system functionality. Examples of the variety of functions are audio/video (A/V) data processing, other high parallel data applications for the medicine and business fields, processing instructions of a general-purpose instruction set architecture (ISA), digital, analog, mixed-signal and radio-frequency (RF) functions, and so forth.

The hardware uses a variety of types of clients. Examples of the clients are a variety of types of processing circuits, application specific integrated circuits (ASICs), field programmable gate arrays (FPGAs), and so forth. Each of the types of clients includes circuitry for generating memory access requests and processing data to provide one of the variety of types of functionalities. In some cases, the hardware uses side-by-side stacked semiconductor dies to offer more computational capability and/or more data storage. To further increase throughput, instances of these clients are placed in multiple processing nodes with each processing node executing a respective host operating system.

The clients of these multiple processing nodes, or the multi-node system, transmit and receive large amounts of data within a corresponding processing node and between processing nodes. The host operating systems manage the storage of data and address mappings within a corresponding processing node based on a workload being executed by the corresponding processing node. Other processing nodes are unaware of this management but execute applications that remotely target the data. How the targeted data is managed locally in the processing node by the corresponding host operating system can affect remote accesses such as increasing latencies of these remote accesses.

In view of the above, efficient methods and mechanisms for efficiently performing remote memory access requests in a multi-node system are desired.

### BRIEF DESCRIPTION OF THE DRAWINGS

FIG. 1 is a generalized diagram of a computing system that efficiently performs remote memory access requests among multiple processing nodes.

FIG. 2 is a generalized diagram of address space assignments that efficiently performs remote memory access requests among multiple processing nodes.

FIG. 3 is a generalized diagram of a sequence diagram that efficiently performs remote memory access requests among multiple processing nodes.

FIG. 4 is a generalized diagram of a sequence diagram that efficiently performs remote memory access requests among multiple processing nodes.

FIG. 5 is a generalized diagram of network messages used for efficiently performing remote memory access requests among multiple processing nodes.

FIG. 6 is a generalized diagram of a method for efficiently performing remote memory access requests among multiple processing nodes.

FIG. 7 is a generalized diagram of a method for efficiently performing remote memory access requests among multiple processing nodes.

FIG. 8 is a generalized diagram of a method for efficiently performing remote memory access requests among multiple processing nodes.

FIG. 9 is a generalized diagram of a method for efficiently performing remote memory access requests among multiple processing nodes.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently performing remote memory access requests among multiple processing nodes are disclosed. In various implementations, a computing system includes at least a first processing node (or first node) and a second node. Each of the first node and the second node executes a respective host operating system. Each of the first node and the second node also has a corresponding virtual address space in the computing system, and each of the first node and the second node assigns subdivisions of the assigned virtual address spaces to its multiple clients within itself. The client executing a first host operating system of the first node creates local virtual-to-physical address mappings for the multiple clients of the first node. The client executing a second host operating system of the second node performs similar steps for the second node.

The physical addresses of these local virtual-to-physical address mappings of the first node point to (or identify) physical data storage locations within the first node. Examples of these physical data storage locations are data storage locations within a video frame buffer of a parallel data processing circuit such as a graphics processing unit (GPU). Other examples of these physical data storage locations are data storage locations within system memory of the first node. Typically, the system memory is implemented by one of a variety of types of dynamic random-access memory (DRAM). The physical addresses of these local virtual-to-physical address mappings of the second node point to (or identify) similar types of data storage locations within the second node. At times due to a currently running workload, the first node sends data and corresponding virtual-to-physical address mappings out of the first node to a lower level of the memory system such as secondary storage. Typically, secondary storage is implemented by a hard driver disk (HDD) or a solid-state drive (SSD).

To support higher throughput and further data sharing, the nodes of the computing system support assigning a subset of a first virtual address space of a first client in the first node to remote data stored in a second virtual address space of a second client in the second node. However, the remote data (remote to the first node) can be moved from the second node to secondary storage based on the workload running on the second node. Prior to sending memory access requests to the second node targeting this remote data, the first node sends a remote presence check (RPC) request to the second node. The second node sends an RPC response indicating whether the targeted data is still stored in the second node, the targeted data is stored in secondary storage, or the request is invalid since the second node is not assigned to store the targeted data.

Typically, nodes send memory access requests targeting remote data (data stored in a remote node) without checking ahead of time the status of the remote data at the second node. Should the remote node need to access secondary storage to service the memory access request, the latency is large and the one or more applications running on the requesting node can become idle for a long duration of time. Therefore, performance of the multi-node computing system reduces. To support checking the status of the remote data at other nodes prior to sending memory access requests, remote presence check (RPC) circuits or other control circuitry of the nodes assign the second virtual address space of the second node to a subset of a network physical address (NPA) space, which is divided among the multiple nodes. The RPC circuit of the second node stores the network-physical-to-virtual address mappings in the second node. The RPC circuit of the second node sends the network-physical-to-virtual address mappings to at least the first node using an export operation. Here, the second node is the exporting node, and the first node is the importing node.

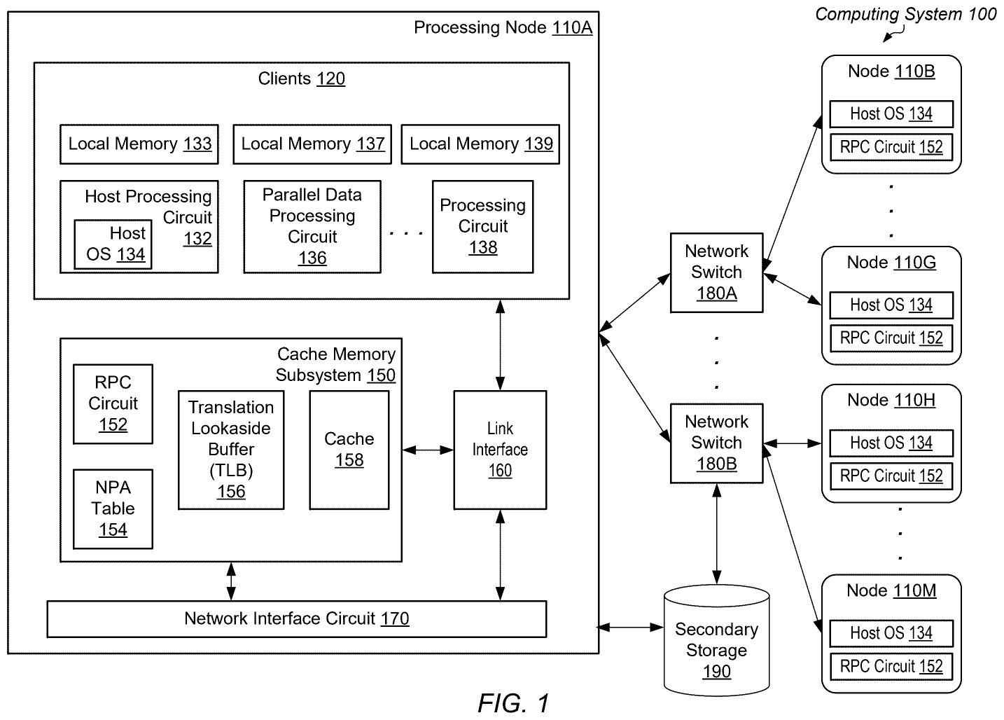

Using the subset of the first virtual address space of the first node and the received network-physical-to-virtual mappings, the RPC circuit of the first node creates, at the first node, virtual-to-network-physical address mappings. The RPC circuit at the first node stores the virtual-to-network-physical address mappings in a translation lookaside buffer (TLB). When a client of the first node generates a memory access request targeting a network physical address assigned to the second node, rather than send the memory access request, the first node instead sends an RPC request that checks the status of the remote data at the second node. The second node sends the RPC response indicating whether the targeted data is still stored in the second node or stored in secondary storage. In some implementations, the second node sends an indication to the first node when the second node moves data corresponding to a network physical address to main memory. Further details of these techniques for efficiently performing remote memory access requests among multiple processing nodes are provided in the following description of FIGS. 1-9.

Referring to FIG. 1, a generalized block diagram is shown of a computing system 100 that efficiently performs remote memory access requests among multiple processing nodes is shown. As shown, computing system 100 includes secondary storage 190 and processing nodes 110A-110M connected to one another through network switches 180A and 180B. Processing node 110A includes clients 120, cache memory subsystem 150, link interface 160 and network interface circuit 170. In some implementations, the components of processing node 110A (or node 110A) are individual dies on an integrated circuit (IC), such as a system-on-a-chip (SOC). In other implementations, the components are individual dies in a system-in-package (SiP) or a multi-chip module (MCM). Interrupt controllers, clock generating circuitry, power managers, a communication fabric, and so on, are not shown for ease of illustration.

Each of the processing nodes 110A-110M (or nodes 110A-11M) executes its own host operating system. For example, host processing circuit 132 executes host operating system 134 of node 110A. As used herein, a “processing node,” which is also referred to as a “node,” refers to a self-contained collection of data processing components within a distributed computing architecture where the collection of data processing components includes multiple clients with at least one host client, memory local to the collection of data processing components, and access to each of secondary storage and other nodes. A host client of multiple clients executes the host operating system of the node. Other clients are capable of executing guest operating systems supporting virtual machines, but the host client executes the host operating system. Memories local to the node include a cache memory subsystem and system memory provided by one of variety of types of dynamic random-access memories (DRAMs). The total memory local to the node is referred to as “primary memory” for the node. “Secondary memory” refers to hard disk drives (HDDs), solid state drives (SSDs) and other non-volatile types of data storage devices. To support communication with other nodes, a node typically includes a network interface.

As shown, processing node 110A includes the defined collection of data processing components such as clients 120, which includes host processing circuit 132 (host client) that executes the host operating system 134, cache memory subsystem 150 and local memories 133, 137 and 139, and via link interface 160 and network interface circuit 170, access to nodes 110B-M. In various implementations, each of nodes 110B-110M includes the collection of data processing components of node 110A. Although a particular number of nodes 110A-110M and network switches 180A-180B are shown, any number of nodes and network switches are used in other implementations based on design requirements.

Network interface circuit 170 includes circuitry of multiple queue and communication circuits supporting a communication protocol with network switches 180A and 180B. Network switch 180A communicates with at least node 110A and nodes 110B-110G. Network switch 180B communicates with at least node 110A and nodes 110H-110M. In some implementations, interface 160 supports a communication protocol connection for transferring commands and data with a system bus, peripheral devices or other. Examples of the communication protocol are PCIe (Peripheral Component Interconnect Express), Infinity Fabric from Advanced Micro Devices, Inc., Infinity Architecture from Advanced Micro Devices, Inc., InfiniBand, RapidIO, HyperTransport, and so forth. Other examples of communication protocols are also possible and contemplated.

Clients 120 of processing node 110A includes host processing circuit 132, parallel data processing circuit 136 and processing circuit 138. An example of host processing circuit 132 is a general-purpose central processing unit (CPU) or central processing circuit. An example of parallel data processing circuit 136 is one of a graphics processing unit (GPU), a digital signal processor (DSP), a field programmable gate array (FPGA), or other type of processor capable of simultaneously processing a same instruction on multiple data items. An example of processing circuit 138 is another parallel processing circuit, an application specific integrated circuit (ASIC), one of a variety of types of a hardware accelerator, and so on.

Parallel data processing circuit 136 has a high parallel data microarchitecture with a significant number of parallel execution lanes. The high parallel data microarchitecture provides high instruction throughput for a computationally intensive task. In one embodiment, the microarchitecture uses a single-instruction-multiple-data (SIMD) pipeline for the parallel execution lanes. Compilers extract parallelized tasks from program code to execute in parallel on the system hardware. Software development kits (SDKs) and application programming interfaces (APIs) were developed for use with widely available high-level languages to provide supported function calls. The function calls provide an abstract layer of the parallel implementation details of the variety of types of parallel data processing circuits. The details are hardware specific to the parallel data processing circuits but hidden to the developer to allow for more flexible writing of software applications. The parallelized tasks come from at least scientific, medical and business (finance) applications with some utilizing neural network training. The tasks include subroutines of instructions to execute. In various embodiments, the multiple execution lanes of the parallel data processor 136 simultaneously execute a wavefront, which includes multiple work-items. A work-item is the same instruction to execute with different data. A work-item is also referred to as a thread.

Processing node 110A includes one or more buses and a communication fabric to transfer information back and forth between the components of processing node 110A. The buses and communication fabric include metal traces, such as transmission lines, queues for storing requests and responses, selection circuitry for arbitrating between received requests before sending requests across an internal network, packing circuitry for building and decoding packets, and control circuitry for selecting routes for the packets and supporting one or more communication protocols. In an implementation, processing node 110A has multiple types of local memory with each being a type of off-chip (or off-die) memory. In an implementation, local memory 133 is system memory for host processing circuit 132, parallel data processing circuit 136 and processing circuit 138. Local memory 133 can be implemented by one of a variety of types of dynamic random-access memory (DRAM).

In an implementation, local memory 137 is a video graphics memory, such as a frame buffer, for parallel data processing circuit 136. In some implementations, local memory 137 is one of a variety of types of synchronous dynamic random-access memory (SDRAM) specifically designed for applications requiring both high memory data bandwidth and high memory data rates. In some implementations, local memory 337 and parallel data processing circuit 136 use a point-to-point (P2P) communication channel, which is a dedicated communication channel between a single source and a single destination. In an implementation, local memory 137 supports a communication protocol such as the Graphics Double Data Rate (GDDR) protocol. Local memory 139 can be shared among the processing circuits 132, 136 and 138, or it can be a dedicated memory for processing circuit 138.

Cache memory subsystem 150 includes one or more caches, such as cache 158, with each being a corresponding level of a cache memory hierarchy for processing node 110A. Cache fill data received from system memory is conveyed to a corresponding one or more of the caches, such as cache 158, and internal cache memories of the clients 120. In other words, the cache fill line is placed in one or more levels of caches. In some designs, one or more of the clients 120 includes a level one (L1) instruction cache and an L1 data cache. Cache 158 provides one or more of a level two (L2) cache and a level three (L3) cache used in the hierarchical cache memory subsystem. Other numbers of levels and other placement of the caches whether internal to the clients 120 or external placement are possible and contemplated.

Users prefer to more easily extend their applications to use different types of clients without explicitly copying data or transforming pointer-based data structures. To allow such an extension of their applications, two or more of the multiple types of clients 120 support generating memory accesses using virtual addresses. Supporting virtual memory for two or more of the clients 120 includes translating a virtual address to a physical address for these clients on each memory access. Lower-level memory, such as local memory 133 being used as system memory, stores page tables that include address mappings of initial addresses to final addresses. In some implementations, the initial addresses are virtual addresses (linear addresses), and the final addresses are physical addresses where virtual pages are loaded in the physical memory.

The physical memory of node 110A can include the local memories 133, 137 and 139. Therefore, the physical addresses of the virtual-to-physical address (VA-to-PA) mappings point to physical data storage locations in one of local memories 133, 137 and 139. A virtual address space used by a software process executed by one of the clients 120 is typically divided into pages of a prefixed size. Examples of the pages sizes are 4 kilobytes (KB), 64 KB, 256 KB, 1 gigabyte (GB), 8 terabytes (TB), and so forth. The virtual pages are mapped to frames of physical memory. The mappings of virtual addresses to physical addresses where virtual pages are loaded in the physical memory are stored in one of the page tables. The translation lookaside buffers (TLBs) 156 uses a cache memory storage arrangement to store a subset of address translation mappings of one or more page tables.

Each of the nodes 110A-110M has a corresponding virtual address space in the computing system 100, and each of the nodes 110A-110M assigns subdivisions of the virtual address spaces to clients 120. The client executing the host operating system (OS) 134, such as host processing circuit 132, supports local virtual-to-physical address (VA-to-PA) mappings for other clients of clients 120. Memory maps are maintained for determining which addresses are mapped to which component, and hence to which component a memory request for a particular address should be routed. Secondary storage 190 includes one or more of a variety of non-volatile types of data storage devices such as hard disk drives (HDDs), solid-state drives (SSDs), optical discs, and portable flash memory such as USB drives and memory cards or sticks. Secondary storage 190 can be referred to as “secondary memory” and the local memories 133, 137 and 139, and the caches in the nodes 110A-110M can be referred to as “physical memory” or “primary memory.” Secondary storage 190 provides larger amounts of data storage than primary memory, but also has longer access times.

As used herein, a “remote node” is separate, different node, which includes its own collection of data processing components described earlier for processing node 110A and executes its own host operating system. Node 110A executes host operating system 134, whereas node 110B executes a separate, different host operating system. Therefore, each of nodes 110A and 110B manage their corresponding address spaces separately from one another after the initial assignments generated at the system level. Accordingly, node 110B is a remote node to node 110A. Likewise, node 110A is a remote node to node 110B. As used herein, “remote data” refers to data stored in a data storage location pointed to by a physical address of a physical address space assigned to another node.

To support higher throughput and further data sharing, the nodes 110A-110M assign a subset of a first virtual address space of one of clients 120 in node 110A to remote data stored in a second virtual address space of a client in node 110B. Similarly, a subset of the second virtual address space of one of clients in node 110B is assigned to remote data stored in the first virtual address space of one of the clients 120 in node 110A. A network physical address space (NPA) is an address space of computing system 100 reserved for the sharing of remote data between nodes 110A-110M. The NPA is divided and each division of the NPA is assigned to one of nodes 110A-110M. One of the host processing circuit 132 executing host operating system 134 and the remote presence check (RPC) circuit 152 assigns a subset of the virtual address space of node 110A to a subset of the NPA space. The RPC circuit 152 stores the network-physical-to-virtual address (NPA-to-VA) mappings in node 110A such as in NPA table 154. The RPC circuit 152 sends the network-physical-to-virtual address (NPA-to-VA) mappings to node 110B using an export operation. Here, node 110A is the exporting node and node 110B is the importing node.

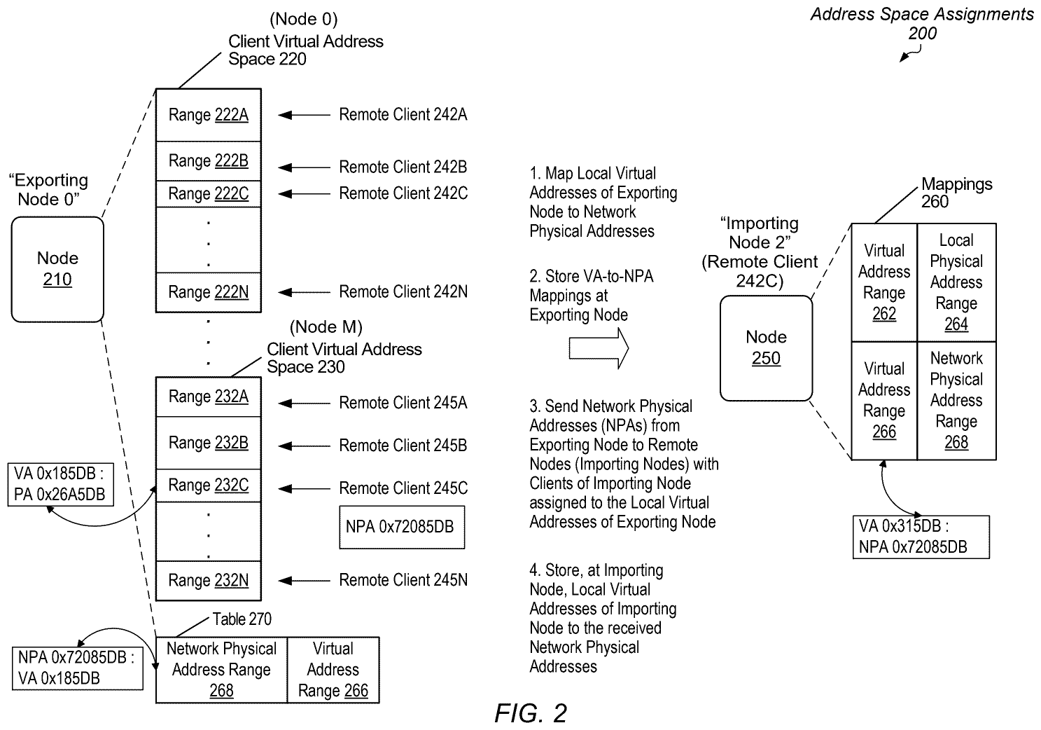

Using the subset of the first virtual address space and the received network-physical-to-virtual address (NPA-to-VA) mappings based on the second virtual address space, the RPC circuit of node 110B creates local virtual-to-network-physical address (VA-to-NPA) mappings. The RPC circuit 152 of node 110A stores the local virtual-to-network-physical address (VA-to-NPA) mappings in TLB 156. Node 110B stores its own local virtual-to-network-physical address (VA-to-NPA) mappings, which are different from the (VA-to-NPA) mappings of node 110A, in its own TLB. These separate mappings are further shown and described in the address space assignments 200 (of FIG. 2).

To further increase the throughput of computing system 100, virtualization of hardware resources is used to allow a single client of clients 120 to process tasks as if the single client operates as multiple clients. Virtualization uses software that defines abstract layers that provide multiple virtual machines, each with its own guest operating system and a portion of the available hardware resources of the processing node such as node 110A. Each virtual machine can be assigned a portion of the available hardware resources corresponding to the tasks performed by the virtual machine, and the remaining hardware resources are then available for other tasks to run on other virtual machines.

Based on a currently used workload, the guest operating system of a virtual machine running on one of the clients 120 of node 110A can relocate one or more of the virtual-to-physical address (VA-to-PA) mappings and network-physical-to-virtual address (NPA-to-VA) mappings from node 110A to secondary storage 190. Node 110B is considered a remote node in relation to node 110A due to executing a separate host operating system different from host operating system 134. A client of node 110B can generate a memory access request that targets the page of data using the address mappings of node 110A relocated from node 110A to secondary storage 190. Sending this memory access request from node 110B to node 110A and then waiting for the address mappings to be retrieved from secondary storage 190 by node 110A before servicing the memory access request, requires a large latency due to the slow access times of secondary storage 190 and the longer access paths. Rather than send the memory access request, the RPC circuit of node 110B instead sends an RPC request. The RPC request from node 110B checks the status of the address mappings of the target address at node 110A. Node 110A sends an RPC response indicating a retry step should be taken later. In the meantime, node 110A takes steps to retrieve the targeted address mappings from secondary storage 190. In some implementations, node 110A sends an indication to at least node 110B when node 110A moves address mappings corresponding to a network physical address range to secondary storage 190.

Referring to FIG. 2, a generalized diagram is shown of address space assignments 200 used for efficiently performing remote memory access requests among multiple processing nodes. In various implementations, each of nodes 210 and 250 has the same functionality as nodes 110A-110M (of FIG. 1) and includes the components and sub-components of nodes 110A-110M. Each of the nodes 210 and 250 has a corresponding virtual address space in the computing system, and each of the nodes 210 and 250 assigns subdivisions of the virtual address spaces to corresponding clients. For example, node 210 has virtual address space 220 (for client 0) and virtual address space 230 (for client M). Virtual address space 220 includes ranges 222A-222N, each being a range of virtual-to-physical address (VA-to-PA) mappings for data accessible by node 210 and one of the remote clients 242A-242N. In various implementations, one or more of the remote clients 242A-242N is a virtual machine running on a remote node. In some implementations, each physical address is a pointer or other identification information that specifies a data storage location in physical memory of node 210. Examples of the physical memory are the local memories 133, 137 and 139 (of FIG. 1). In an implementation, the address mappings correspond to a page of data that has a size of 4 kilobytes (KB) although other sizes are possible and contemplated. Therefore, the page index is different between the virtual address and the physical address, but the least significant 12 bits (for a page size of 4 KB) have the same value. Therefore, the least significant 12 bits of each of the virtual address and the physical address have the same value. Each of ranges 222A-222N can include a range of page indexes for virtual-to-physical address (VA-to-PA) mappings. Virtual address space 230 includes ranges 232A-232N, each being a range of virtual-to-physical address (VA-to-PA) mappings for data accessible by node 210 and one of the remote clients 245A-245N.

One of the host processing circuit (host client) executing its host operating system and remote presence check (RPC) circuit of node 210 assigns range 232C of virtual address space 230 of node 210 to a subset of a network physical address (NPA) space. One of the host processing circuit and remote presence check (RPC) circuit of node 210 maintains the NPA table 270 that stores network-physical-to-virtual address (NPA-to-VA) mappings in node 210. In various implementations, NPA table 270 has the same functionality as NPA table 154 (of FIG. 1). NPA table 270 includes the mappings of the NPA range 268 and the virtual address range 266. For example, the NPA table 270 stores the mapping between NPA address 0x72085DB and the virtual address 0x185DB of node 210. The RPC circuit of node 210 sends at least the NPAs of the mappings in NPA table 270 associated with node 250 to node 250 using an export operation. Here, node 210 is the exporting node and node 250 is the importing node. Therefore, node 210 sends at least NPA address 0x72085DB and an indication of remote client 245C to node 250.

Using the information of the export operation, the RPC circuit of node 250 creates virtual-to-network-physical address mappings such as the mapping between the virtual address 0x315DB local to node 250 and NPA address 0x72085DB. The mappings 260 are updated with this mapping. Mappings 260 includes mappings between the virtual address range 262 and local physical address range 264. The physical addresses of the local physical address range 264 identify data storage locations in primary memory of node 250. Mappings 260 also includes mappings between the virtual address range 266 and network physical address range 268. The physical addresses of the network physical address range 268 point to data storage locations in primary memory of nodes other than node 250. The RPC circuit of node 250 stores the virtual-to-network-physical address (VA-to-NPA) mappings in a TLB. The nodes 210 and 250 perform remote presence check requests and responses to determine, prior to routing memory access requests, whether address mappings in TLBs are still available within a corresponding node and haven't been removed from the corresponding node to have copies stored only in secondary storage. For example, each of the host operating systems executing on nodes 210 and 250 supports hardware virtualization and sets up multiple virtual machines, each with its own guest operating system and a portion of the available hardware resources of the processing node of the multi-node system.

Each virtual machine can be assigned a portion of the available hardware resources corresponding to the tasks performed by the virtual machine, and the remaining hardware resources are then available for other tasks run on other virtual machines. With the use of multiple virtual machines, users execute multiple independent guest operating systems on the same hardware resources of the nodes 210 and 250. Based on a currently used workload, the guest operating system of a virtual machine running on node 210 can relocate address mappings from TLBs and local physical memories, such as local memories 133, 137 and 139 (of FIG. 1), of node 210 to secondary storage such as secondary storage 190 (of FIG. 1). In some implementations, node 210 sends an indication to at least node 250 when node 210 moves, to secondary memory, address mappings corresponding to a network physical address range assigned to node 250.

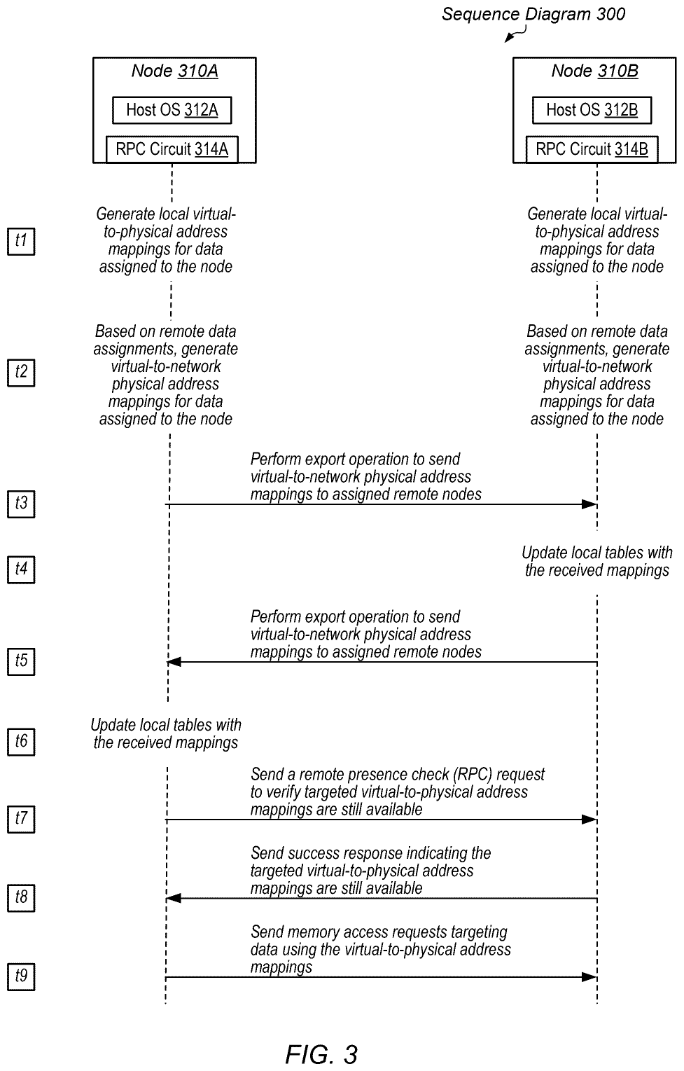

Turning now to FIG. 3, a generalized diagram is shown of a sequence diagram 300 that efficiently performs remote memory access requests among multiple processing nodes. In the illustrated implementation, processing nodes (or nodes) 310A and 310B communicate with one another across one or more network switches (not shown). In various implementations, each of nodes 310A and 310B has the same functionality and include the same components as nodes 110A-110M (of FIG. 1). Each of nodes 310A and 310B has a client that executes a corresponding host operating system such as host OS 312A and host OS 312B. Host OS 312A and host OS 312B supports hardware virtualization and sets up multiple virtual machines. Each of nodes 310A and 310B has a corresponding remote presence check (RPC) circuit, such as RPC circuit 314A and RPC circuit 314B, for supporting efficient remote memory accesses in a multi-node computing system. Although only two nodes are shown, the corresponding computing system can include any number of nodes based on design requirements. It is noted that the sequence diagrams provided herein are provided for ease of discussion and are not intended to indicate a strict ordering of events. Rather, some of the events can occur concurrently and can occur in a different order. Each of nodes 310A and 310B has a corresponding virtual address space in the computing system. At the point in time t1 (or time t1), each of nodes 310A and 310B generates local virtual-to-physical address mappings for data assigned to the node. The physical addresses point to, or otherwise identify, data storage locations in physical memory of the corresponding node. Examples of physical memory are primary memories such as cache memory subsystem 150 and local memories 133, 137 and 139 (of FIG. 1).

At time t2, based on remote data assignments, each of nodes 310A and 310B generates virtual-to-network physical address (VA-to-NPA) mappings for data assigned to the node. In some implementations, one or more of the nodes 310A and 310B has at least one virtual machine executing on a client that supports a page table that maps corresponding virtual addresses to the network physical addresses (NPAs). These network physical addresses belong to the network physical address space of the computing system that identifies data storage locations of remote clients in remote nodes. When a local virtual address is translated to a network physical address in the NPA space, the corresponding memory access request is routed to a remote client of a remote node. At time t3, node 310A performs an export operation to send virtual-to-network physical address (VA-to-NPA) mappings to assigned remote nodes such as node 310B. In this export operation, node 310A is the exporting node and node 310B is the importing node.

At time t4, node 310B updates local tables (page tables) with the received mappings. At time t5, node 310B performs an export operation to send virtual-to-network physical address (VA-to-NPA) mappings to assigned remote nodes such as node 310A. In this export operation, node 310B is the exporting node and node 310A is the importing node. At time t6, node 310A updates local tables (page tables) with the received virtual-to-network physical address (VA-to-NPA) mappings. At time t7, node 310A sends a remote presence check (RPC) request to verify targeted virtual-to-physical address (VA-to-PA) mappings of node 310B are still available in node 310B and haven't been removed from node 310B and now have a single copy stored in secondary. An example of secondary storage is secondary storage 190 (of FIG. 1). Node 310B receives the RPC request.

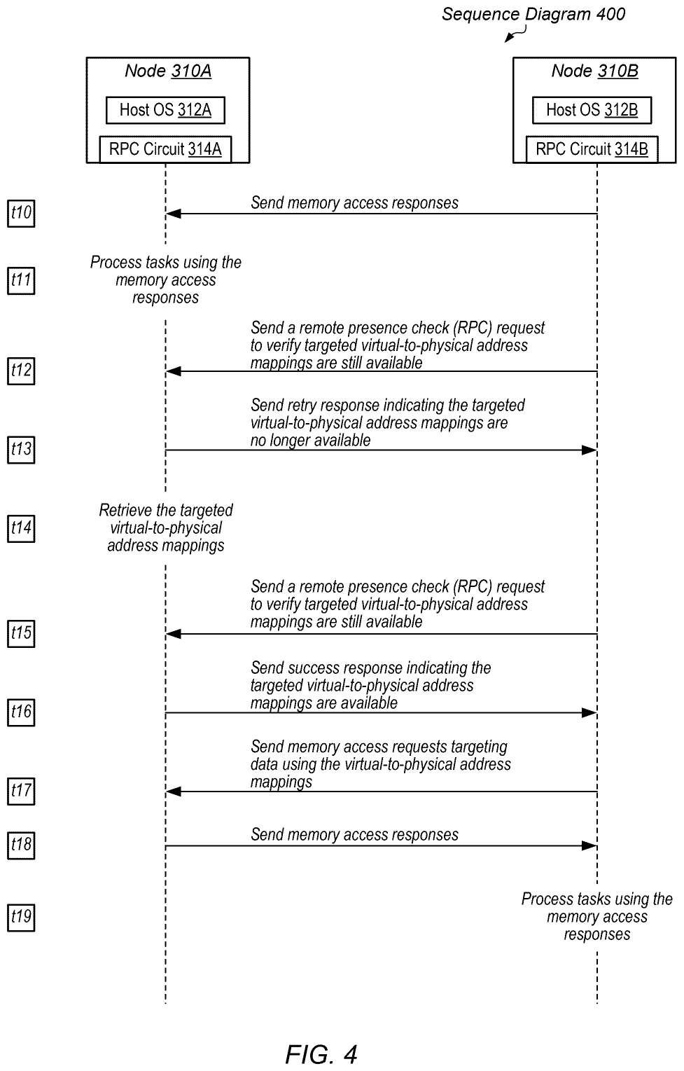

At time t8, node 310B sends a success response indicating the targeted virtual-to-physical address mappings are still available within node 310B. For example, the circuitry of node 310B found the targeted virtual-to-physical address mappings in a TLB of node 310B. Alternatively, node 310B found the targeted virtual-to-physical address mappings in a local physical memory of node 310B. Examples of the local physical memories are the local memories 133, 137 and 139 (of FIG. 1). When node 310B does not find the targeted virtual-to-physical address mappings in its one or more TLBs, node 310A performs a page table walk. If the page table walk locates the targeted virtual-to-physical address mappings in one of the local physical memories, then node 310A sends the RPC success response to node 310A. If the page table walk does not locate the targeted virtual-to-physical address mappings in one of the local physical memories, then node 310A does not send the RPC success response to node 310A. Rather, node 310B sends an RPC retry response, which is further described in sequence diagram 400 (of FIG. 4). At time t8, node 310A receives the response. At time t9, node 310A sends memory access requests targeting data using the targeted virtual-to-physical address mappings. The memory access requests include at least memory read requests and memory write requests.

Referring to FIG. 4, a generalized diagram is shown of a sequence diagram 400 that efficiently performs remote memory access requests among multiple processing nodes. Circuitry and components described earlier are numbered identically. Sequence diagram 400 continues after sequence diagram 300 (of FIG. 3). At time t10, node 310B sends memory access responses corresponding to the memory access requests received at time t9 (of FIG. 3). At time t11, node 310A processes tasks using the memory access responses.

At time t12, node 310B sends a remote presence check (RPC) request to verify targeted virtual-to-physical address (VA-to-PA) mappings of node 310A are still available in node 310A and haven't been removed from node 310A and have a single copy now stored in secondary storage. Node 310A receives the RPC request. At time t13, node 310A sends a retry response indicating the targeted virtual-to-physical address (VA-to-PA) mappings are no longer available in any data storage of node 310A. For example, node 310A did not find the targeted virtual-to-physical address mappings in any TLB of node 310A and the resulting page table walk did not locate the targeted virtual-to-physical address mappings in any local physical memory of node 310A. Node 310B receives the retry response. At time t14, node 310A retrieves the targeted virtual-to-physical address mappings from secondary storage. At time t15, node 310B again sends an RPC request to verify targeted virtual-to-physical address mappings are available at node 310A.

At time t16, node 310A sends a success response indicating the targeted virtual-to-physical address mappings are available at node 310A. Node 310B receives the response. At time t17, node 310B sends memory access requests targeting data using the virtual-to-physical address mappings. The memory access requests include at least memory read requests and memory write requests. At time t18, node 310A sends memory access responses corresponding to the memory access requests received at time t17. At time t19, node 310B processes tasks using the memory access responses.

It is possible and contemplated that prior to time t13, due to a currently running workload, a virtual machine or other client on node 310A relocates a range of one or more of the virtual-to-physical address (VA-to-PA) mappings and network-physical-to-virtual address (NPA-to-VA) mappings from node 310A to secondary. An example of secondary storage is secondary storage 190 (of FIG. 1). At this time, in some implementations, node 310A (exporter node in this case) sends an indication to at least node 310B (importer node in this case) indicating that these mappings are no longer stored at node 310A, but rather now are stored in secondary storage. When the node 310B (importer node in this case) receives the indication, in an implementation, node 310B marks or otherwise stores an indication indicating that the virtual-to-network physical address (VA-to-NPA) mappings are currently unavailable at node 310A due to being moved out of node 310A. This marking allows node 310B to be aware that this marked range of virtual-to-network physical address (VA-to-NPA) mappings should not include page table walks after TLB misses followed by an interrupt due to not finding this marked range of virtual-to-network physical address (VA-to-NPA) mappings. Rather, node 310B should generate and send an RPC request to node 310A. Additionally, node 310A flushes any path of execution using this marked range of virtual-to-network physical address (VA-to-NPA) mappings.

Should a client of node 310B generate a memory access request targeting this range of marked virtual-to-network physical address (VA-to-NPA) mappings, node 310B generates and sends a RPC request to node 310A as described earlier. The requested virtual-to-network physical address (VA-to-NPA) mappings are no longer valid but should not include generation of an interrupt due to being unable to find these mappings. In another implementation, after marking the range of virtual-to-network physical address (VA-to-NPA) mappings, node 310B (importer node) waits for a threshold duration of time before sending the RPC request even if no client has yet requested data using this marked range of virtual-to-network physical address (VA-to-NPA) mappings. In some implementations, node 310A (exporter node) generates commands to mark the range of virtual-to-network physical address (VA-to-NPA) mappings in node 310B (importer node) and sends these commands to a ring buffer in a reserved area of the virtual address space of node 310B (importer node). These commands can be referred to as commands of a “remote TLB shootdown” operation.

In some implementations, prior to sending an indication or commands of the remote TLB shootdown, node 310A (exporter node) updates its local virtual-to-physical address (VA-to-PA) mappings for the range to be removed but allowing the servicing of outstanding remote memory access requests to complete. For any subsequent RPC request being received, node 310A (exporter node) generates the RPC retry response. After node 310A (exporter node) sends the commands of the remote TLB shootdown to node 310B (importer node) and node 310A (exporter node) receives an acknowledgment from node 310B (importer node) that the commands of the remote TLB shootdown operation have been completed, node 310A (exporter node) marks or updates its range of virtual-to-physical address (VA-to-PA) mappings as being unavailable/These mappings have become unavailable due to having been moved or are going to be moved to secondary storage. The corresponding data is also moved to secondary storage.

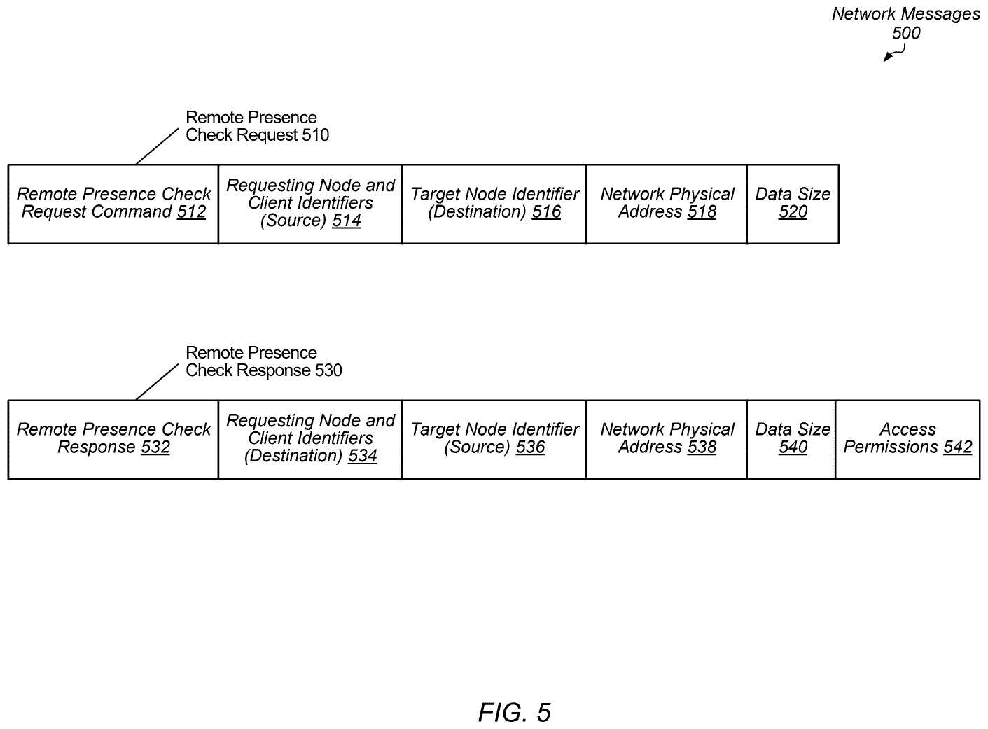

Referring to FIG. 5, a generalized diagram is shown of network messages 500 used for efficiently performing remote memory access requests among multiple processing nodes. In various implementations, circuitry such as remote presence check (RPC) circuit 152 (of FIG. 1) generates network messages 500 when processing remote memory access requests among multiple processing nodes. Network messages include remote presence check (RPC) request 510 and RPC response 530. Although particular information is shown as being stored in the fields 512-520 of RPC request 510 and fields 532-542 of RPC response 530 and in a particular contiguous order, in other implementations, a different order is used, and a different number and type of information is stored.

As shown, field 512 of RPC request 510 stores an indication, such as an opcode, of an RPC request command. Field 514 stores identifiers (IDs) of a client of a requesting node. This client is the source of the RPC request 510. Examples of clients are clients 120 (of FIG. 1) and examples of a node are processing nodes 110A-110M (of FIG. 1) and nodes 210 and 250 (of FIG. 2) and nodes 310A-310B (of FIGS. 3-4). Field 516 stores an identifier (ID) of a client of a target node. The source node is the importing node, and the target node is the exporting node. Field 518 stores the network physical address (NPA) and field 520 stores an indication of the data size of the requested data. In some implementations, the data is a page of virtual-to-physical address mappings that includes a virtual address mapped to the NPA.

Field 532 of RPC response 530 stores an indication of an RPC response or result. In various implementations, the response indicates one of success, retry and failure. The indication of success specifies that the TLB of the target node still stores a page of virtual-to-physical address mappings that includes a virtual address mapped to the NPA. Field 538 stores the NPA. The indication of retry specifies that the TLB of the target node does not currently store the page of virtual-to-physical address mappings that includes a virtual address mapped to the NPA, and the requesting node should retry again later. The indication of failure indicates the NPA stored in field 538 is invalid. Field 534 stores identifiers (IDs) of a client of a requesting node. This client is the source of the RPC request 510 and receives RPC response 530. Field 536 stores an identifier (ID) of a client of a target node. The source node is the importing node, and the target node is the exporting node. Field 540 stores information similar to field 520. Field 542 stores indications of data access permissions corresponding to the page of virtual-to-physical address mappings that includes a virtual address mapped to the NPA. Examples of the data access permissions are no access permission, read only permission, write only permission, read and write permission, and read and execute permission.

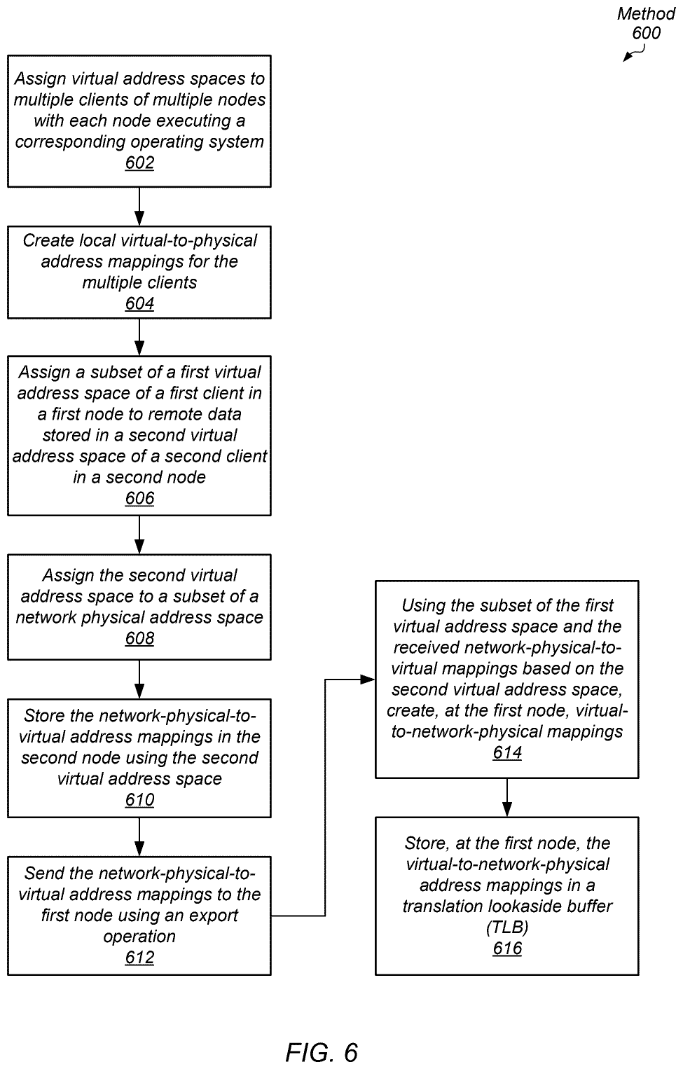

Referring to FIG. 6, a generalized diagram is shown of a method 600 for efficiently performing remote memory access requests among multiple processing nodes. For purposes of discussion, the steps in this implementation are shown in sequential order. However, in other implementations some steps occur in a different order than shown, some steps are performed concurrently, some steps are combined with other steps, and some steps are absent.

For methods 600-900 (of FIGS. 6-9), in various implementations, a computing system includes multiple processing nodes, each executing a corresponding host operating system and includes the circuitry of multiple clients for processing tasks. Examples of clients are clients 120 (of FIG. 1) and examples of a node are processing nodes 110A-110M (of FIG. 1) and nodes 210 and 250 (of FIG. 2) and nodes 310A-310B (of FIGS. 3-4). The processing nodes include remote presence check (RPC) circuits such as RPC circuit 152 (of FIG. 1) and RPC circuits 314A-314B (of FIGS. 3-4). In some implementations, the host operating systems of one or more of the processing nodes supports hardware virtualization and sets up multiple virtual machines. The processing nodes have corresponding virtual address spaces in the computing system, and each processing node (or node) assigns subdivisions of the virtual address spaces to multiple clients of the nodes (block 602). The client executing the host operating system creates local virtual-to-physical address mappings for the multiple clients (block 604).

To support higher throughput and further data sharing, the nodes assign a subset of a first virtual address space of a first client in a first node to remote data stored in a second virtual address space of a second client in a second node (block 606). Remote presence check (RPC) circuits of the nodes assign the second virtual address space to a subset of a network physical address (NPA) space (block 608). The RPC circuit of the second node stores the network-physical-to-virtual address mappings in the second node using the second virtual address space (block 610).

The RPC circuit of the second node sends the network-physical-to-virtual address mappings to the first node using an export operation (block 612). Here, the second node is the exporting node, and the first node is the importing node. Using the subset of the first virtual address space and the received network-physical-to-virtual mappings based on the second virtual address space, the RPC circuit of the first node creates, at the first node, virtual-to-network-physical mappings (block 614). The RPC circuit at the first node stores the virtual-to-network-physical address mappings in a translation lookaside buffer (TLB) (block 616).

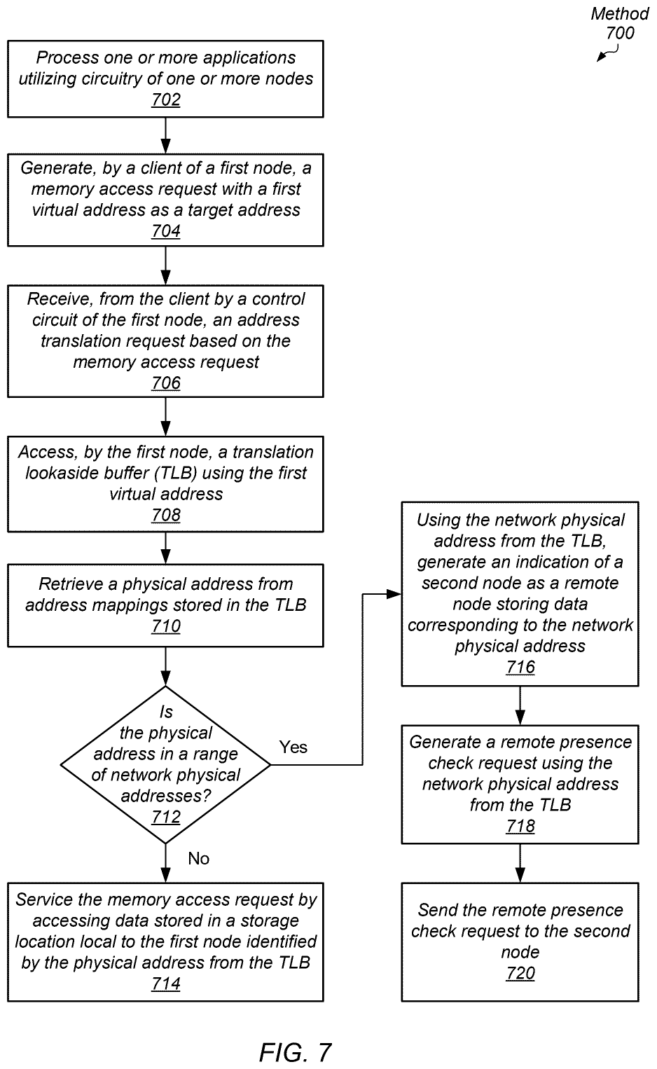

Turning now to FIG. 7, a generalized diagram is shown of a method 700 for efficiently performing remote memory access requests among multiple processing nodes. The computing system processes one or more applications utilizing circuitry of one or more nodes (block 702). A client of a first node generates a memory access request with a first virtual address as a target address (block 704). A control circuit, such as the RPC circuit, of the first node, receives, from the client, an address translation request based on the memory access request (block 706). The first node accesses a translation lookaside buffer (TLB) using the first virtual address (block 708).

The first node retrieves a physical address from address mappings stored in the TLB (block 710). If the physical address is not in a range of network physical addresses (“no” branch of the conditional block 712), then circuitry of the first node services the memory access request by accessing data stored in a storage location local to the first node identified by the physical address from the TLB (block 714). However, if the physical address is in a range of network physical addresses (“yes” branch of the conditional block 712), then using the network physical address from the TLB, the RPC circuit of the first node generates an indication of a second node as a remote node storing data corresponding to the network physical address (block 716). The RPC circuit of the first node generates a remote presence check request using the network physical address from the TLB (block 718). The first node sends the remote presence check request to the second node (block 720). Here, the first node is the importing node, and the second node is the exporting node.

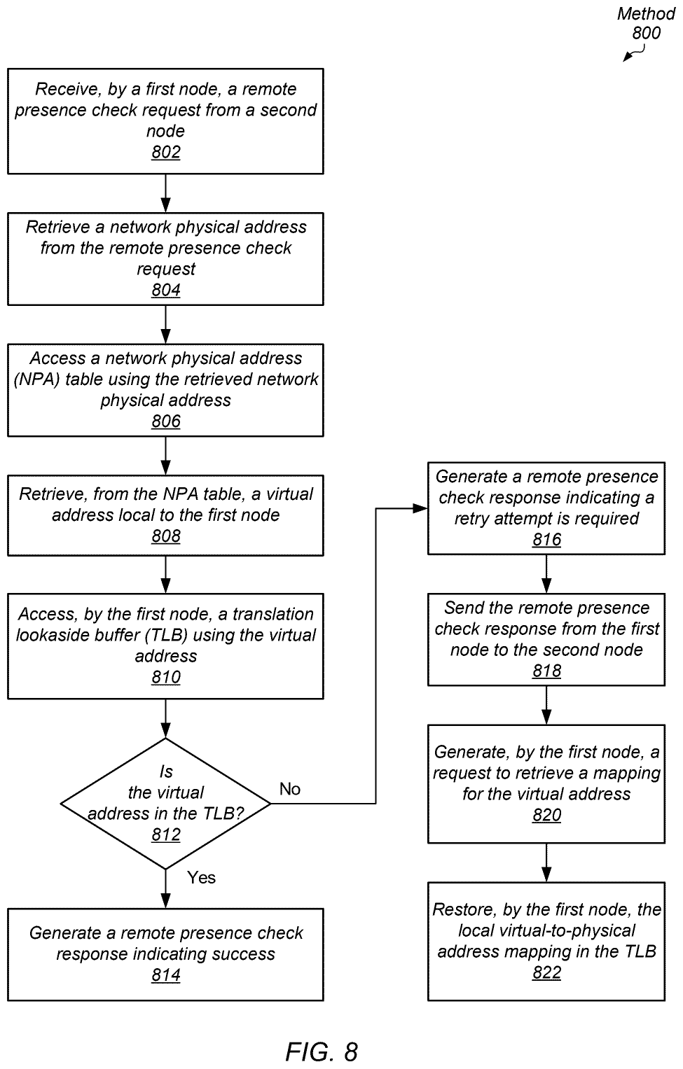

Referring to FIG. 8, a generalized diagram is shown of a method 800 for efficiently performing remote memory access requests among multiple processing nodes. A first node of a multi-node system receives a remote presence check request from a second node (block 802). Here, the first node is the exporting node, and the second node is the importing node. The RPC circuit of the first node (exporting node) retrieves a network physical address from the remote presence check request (block 804). The RPC circuit of the first node (exporting node) accesses a network physical address (NPA) table using the retrieved network physical address (block 806). The RPC circuit retrieves, from the NPA table, a virtual address local to the first node (block 808).

The first node accesses a translation lookaside buffer (TLB) using the virtual address (block 810). If the virtual address is in the TLB (“yes” branch of the conditional block 812), then the first node generates a remote presence check response indicating success (block 814). However, if the virtual address is not in the TLB (“no” branch of the conditional block 812), then the first node generates a remote presence check response indicating a retry attempt is required (block 816). The first node sends the remote presence check response to the second node (block 818). The first node generates a request to retrieve mappings for the virtual address from secondary storage (block 820). The first node restores the local virtual-to-physical address mapping in the TLB (block 822). It is noted that in various implementations, each of the first node and the second node includes circuitry to support the remote TLB shootdown operation described earlier regarding nodes 310A and 310B (of FIG. 3).

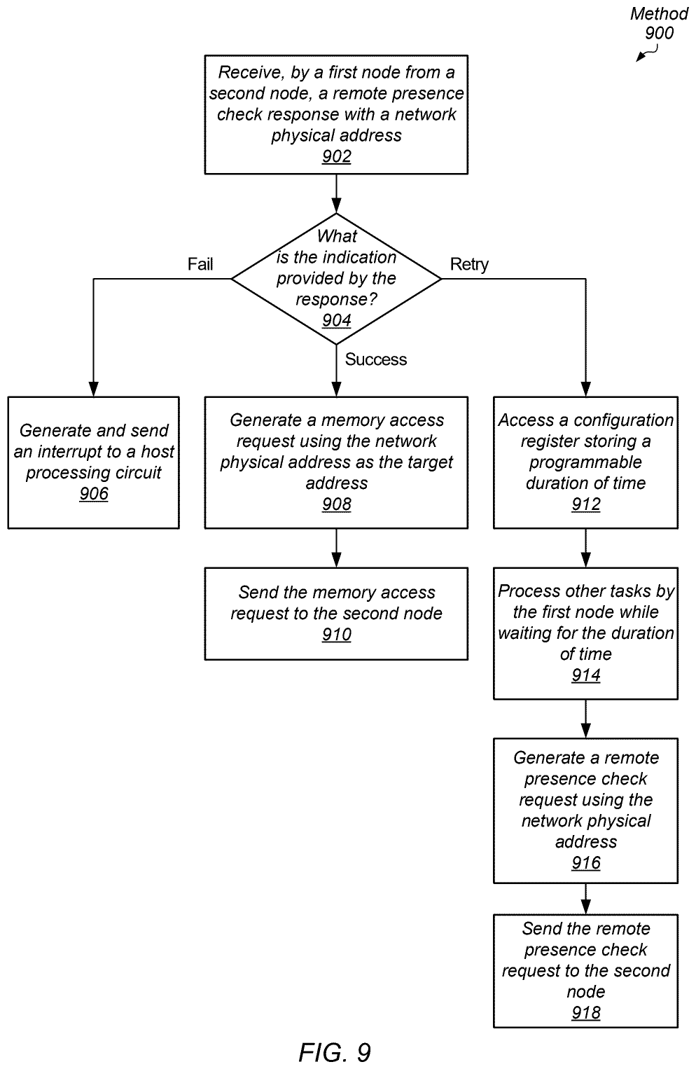

Turning now to FIG. 9, a generalized diagram is shown of a method 900 for efficiently performing remote memory access requests among multiple processing nodes. A first node of the computing system receives, from a second node, a remote presence check response with a network physical address (block 902). Here, the first node is the importing node, and the second node is the exporting node. If the indication provided by the response specifies failure (“Fail” branch of the conditional block 904), then the first node generates and sends an interrupt to a host processing circuit of the first node (block 906). In some implementations, the second node also generates and sends an interrupt to a host processing circuit of the second node. If the indication provided by the response specifies success (“Success” branch of the conditional block 904), then the first node generates a memory access request using the network physical address as the target address (block 908). The first node sends the memory access request to the second node (block 910).

If the indication provided by the response specifies retry (“Retry” branch of the conditional block 904), then the first node accesses a configuration register storing a programmable duration of time (block 912). The first node processes other tasks waiting for the duration of time to elapse (block 914). When the duration of time has elapsed, the first node generates a remote presence check request using the network physical address (block 916). The first node sends the remote presence check request to the second node (block 918).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a plurality of clients comprising circuitry configured to process tasks;
a control circuit configured to:
receive, from a client of the plurality of clients, a first memory access request comprising a first virtual address; and
convey a remote presence check request to a remote processing node, responsive to the first virtual address being mapped to a first physical address of a storage location in the remote processing node.

2. The apparatus as recited in claim 1, wherein the remote presence check request includes the first physical address and requests an indication as to whether the remote processing node includes a mapping of a virtual address to the first physical address.

3. The apparatus as recited in claim 1, wherein responsive to receiving an indication that a second address mapping corresponding to the first physical address is present at the remote processing node, the control circuit is configured to send a second memory access request using the first physical address to the remote processing node.

4. The apparatus as recited in claim 1, wherein responsive to receiving an indication that the second address mapping is not present at the remote processing node, the control circuit is configured to resend the remote presence check request comprising the first physical address to the remote processing node.

5. The apparatus as recited in claim 1, wherein responsive to an indication to remove a third address mapping, the control circuit is configured to:
service outstanding remote memory access requests prior to removing the third address mapping; and
send to at least the remote processing node an indication that the third address mapping is being removed from the apparatus.

6. The apparatus as recited in claim 5, wherein the control circuit is configured to send to at least the remote processing node an indication to retry any memory access request targeting a data storage location identified by the third address mapping.

7. The apparatus as recited in claim 5, wherein the control circuit is configured to remove the third address mapping, responsive to an acknowledgment, from at least the remote processing node, of the indication that the third address mapping is being removed.

8. A method comprising:
processing tasks by circuitry of a plurality of clients of a plurality of processing nodes;
receiving, by circuitry of a first processing node of the plurality of processing nodes, a first memory access request comprising a first virtual address; and
conveying a remote presence check request to a remote processing node, responsive to the first virtual address being mapped to a first physical address of a storage location in the remote processing node.

9. The method as recited in claim 8, wherein the remote presence check request includes the first physical address and requests an indication as to whether the remote processing node includes a mapping of a virtual address to the first physical address.

10. The method as recited in claim 8, wherein responsive to receiving an indication that a second address mapping corresponding to the first physical address is present at the remote processing node, the method further comprises sending, by the first processing node, a second memory access request using the first physical address to the second processing node.

11. The method as recited in claim 8, wherein responsive to receiving an indication that the second address mapping is not present at the remote processing node, the method further comprises resending, by the first processing node, the remote presence check request comprising the first physical address to the remote processing node.

12. The method as recited in claim 8, wherein responsive to an indication to remove a third address mapping, the method further comprises:
servicing, by the first processing node, outstanding remote memory access requests prior to removing the third address mapping; and
sending, by the first processing node to at least the remote processing node, an indication that the third address mapping is being removed from the apparatus.

13. The method as recited in claim 12, further comprising sending, by the first processing node to at least the second processing node, an indication to retry any memory access request targeting a data storage location identified by the third address mapping.

14. The method as recited in claim 12, further comprising removing the third address mapping, responsive to an acknowledgment, from at least the second processing node, of the indication that the third address mapping is being removed.

15. A computing system comprising:
a plurality of processing nodes, each comprising circuitry configured to process tasks;
wherein a first processing node of the plurality of processing nodes comprises:
a plurality of clients comprising circuitry configured to generate memory access requests; and
a control circuit configured to convey a remote presence check request to a second processing node different from the first processing node requesting an indication of whether a first physical address is present at the second processing node, responsive to a first virtual address of a first memory access request is mapped to the first physical address.

16. The computing system as recited in claim 15, wherein the remote presence check request includes the first physical address and requests an indication as to whether the second processing node includes a mapping of a virtual address to the first physical address.

17. The computing system as recited in claim 15, wherein responsive to receiving an indication that a second address mapping corresponding to the first physical address is present at the remote processing node, the control circuit is configured to send a second memory access request using the first physical address to the second processing node.

18. The computing system as recited in claim 15, wherein responsive to receiving an indication that the second address mapping is not present at the second processing node, the control circuit is configured to resend the remote presence check request comprising the first physical address to the remote processing node.

19. The computing system as recited in claim 15, wherein responsive to an indication to remove a third address mapping, the first processing node is configured to:
service outstanding remote memory access requests prior to removing the third address mapping; and
send to at least the second processing node an indication that the third address mapping is being removed from the first processing node.

20. The computing system as recited in claim 19, wherein the first processing node is configured to send to at least the second processing node an indication to retry any memory access request targeting a data storage location identified by the third address mapping.
